(19) United States
(12) Patent Application Publication
(10) Pub. No.: US 2024/0193252 A1
(43) Pub. Date: Jun. 13, 2024

(54) STORAGE DEVICE, AND METHOD AND SYSTEM FOR VERIFYING AND AUTHORIZING BY USING STORAGE DEVICE

(71) Applicant: Wistron Corporation, New Taipei City (TW)

(72) Inventors: Bo Hong He, New Taipei City (TW); Yi-Tsung Cheng, New Taipei City (TW); Hsin-Run Li, New Taipei City (TW)

(73) Assignee: Wistron Corporation, New Taipei City (TW)

(21) Appl. No.: 18/165,943

(22) Filed: Feb. 8, 2023

(30) Foreign Application Priority Data
Dec. 8, 2022 (TW) 111147191

(51) Int. Cl. G06F 21/44

(52) U.S. Cl. CPC G06F 21/44

(57) ABSTRACT

A storage device, and a method and system for verifying and authorizing by using the storage device are provided. In response to determining that the storage device is connected to an electronic device, the storage device triggers the electronic device to use a public key to obtain predetermined hardware information and service information of a service from a certificate. Also, in response to determining that the predetermined hardware information matches device hardware information of the electronic device, the storage device triggers the electronic device to access the service by running the image file, wherein the service information of the service indicates that the electronic device is authorized to use the service.

### CROSS-REFERENCE TO RELATED APPLICATION

This application claims the priority benefit of Taiwan application serial no. 111147191, filed on Dec. 8, 2022. The entirety of the above-mentioned patent application is hereby incorporated by reference herein and made a part of this specification.

### BACKGROUND

### Technical Field

The disclosure relates to a verification and authorization technique, and in particular relates to a storage device, and a method and a system for verifying and authorizing by using the storage device,

### Description of Related Art

When software developers develop software for clients such as the Health Insurance Administration, the Health Promotion Administration, and major hospitals, they often face some relatively special technical problems, and there are currently no ready-made solutions for these technical problems.

For example, for the above-mentioned customers, the network environment used to install software is generally a fully enclosed network environment for both internal and external usage. Moreover, when the developed software includes multiple functional modules, the functional modules purchased by different customers are often different. In addition, because most of the customers do not buy out the software license in a one-off payment, the functional modules purchased by different customers have different expiration dates.

Therefore, for those skilled in the art, how to design a mechanism that may solve the above-mentioned technical problems is an important issue.

### SUMMARY

In view of this, the disclosure provides a storage device, a method and a system for verifying and authorizing by using the storage device, which may be used to solve the above technical problems.

An embodiment of the disclosure provides a storage device storing a public key, a certificate, and at least one image file corresponding to a service. The storage device is configured for the following operation. In response to determining that the storage device is connected to an electronic device, the electronic device is triggered to obtain predetermined hardware information and service information of the service from the certificate by using the public key. In response to determining that the predetermined hardware information matches device hardware information of the electronic device, the electronic device is triggered to access the service by running the at least one image file, in which the service information of the service indicates that the electronic device is authorized to use the service.

An embodiment of the disclosure provides a method for verifying and authorizing by using a storage device. The storage device stores a public key, a certificate, and at least one image file corresponding to a service. The method includes the following operation. In response to determining that the storage device is connected to an electronic device, predetermined hardware information and service information of the service from the certificate are obtained by using the public key. In response to determining that the predetermined hardware information matches device hardware information of the electronic device, the service is accessed by running the at least one image file, in which the service information of the service indicates that the electronic device is authorized to use the service.

An embodiment of the disclosure provides a verification and authorization system, including a storage device and a product server. The product server is configured for the following operation. In response to a service application request, predetermined hardware information and service information of an applied service are obtained. A public key and a private key corresponding to the service application request is generated, and at least one image file corresponding to a service is generated based on the service information of the service. A certificate is generated based on the private key, the predetermined hardware information, and service information of the service, and the public key, certificate, and the at least one image file are stored in the storage device.

### BRIEF DESCRIPTION OF THE DRAWINGS

FIG. 1 is a schematic diagram of a verification and authorization system according to an embodiment of the disclosure.

FIG. 2 is a flowchart for generating software services/products according to an embodiment of the disclosure.

FIG. 3 is a flowchart of a method for verifying and authorizing by using a storage device according to an embodiment of the disclosure.

FIG. 4 is a schematic diagram of a user interface according to an embodiment of the disclosure.

### DETAILED DESCRIPTION OF DISCLOSED EMBODIMENTS

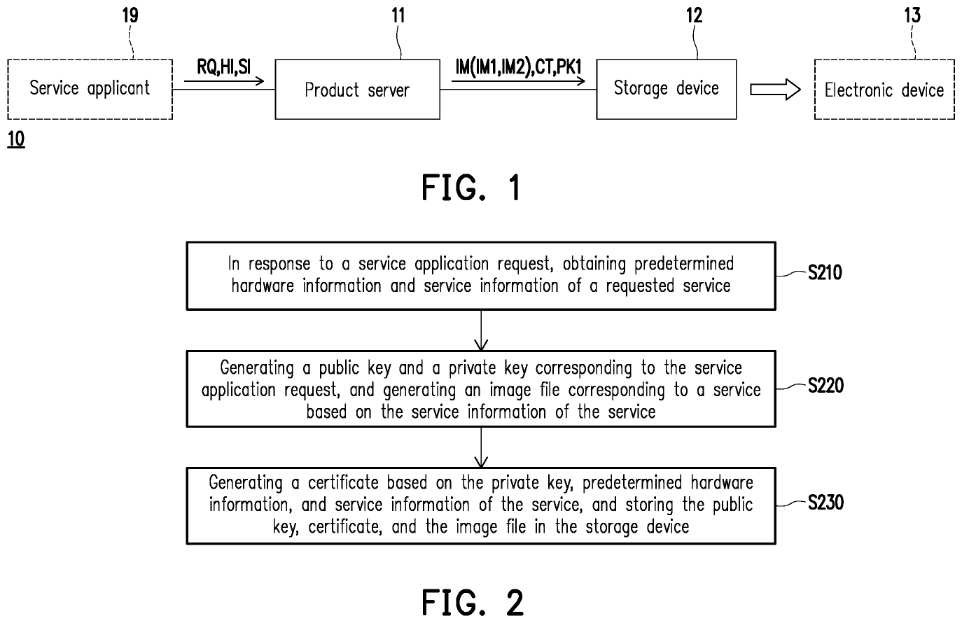

Referring to FIG. 1, FIG. 1 is a schematic diagram of a verification and authorization system according to an embodiment of the disclosure. In FIG. 1, a verification and authorization system 10 includes a product server 11 and a storage device 12. In the embodiment of the disclosure, the product server 11 is, for example, a server maintained by a software developer, which may receive a service application request RQ of a service applicant 19 through the relevant service application platform (e.g., the webpage corresponding to the product server 11), and generate/develop corresponding software services/products for the service applicant 19 accordingly, but not limited thereto.

In different embodiments, the storage device 12 is, for example, any type of fixed or removable random access memory (RAM), read-only memory (ROM), flash memory (Flash memory), a hard disk or other similar devices or a combination of these devices, but not limited thereto.

In an embodiment of the disclosure, the product server 11 may execute the method shown in FIG. 2 to generate corresponding software products according to the requirement of the service applicant 19.

Referring to FIG. 2, FIG. 2 is a flowchart for generating software services/products according to an embodiment of the disclosure. The method of this embodiment may be executed by the product server 11 in FIG. 1, and the details of each step in FIG. 2 will be described below with reference to the elements shown in FIG. 1.

First, in step S210, the product server 11 obtains predetermined hardware information HI and service information SI of the applied service in response to the service application request RQ.

In the embodiment of the disclosure, it is assumed that the software product provided by the product server 11 includes multiple services (e.g., functional modules), and the service applicant 19 may purchase one or more of these services according to requirements.

In one embodiment, the service applicant 19 may select the services to be purchased on the above-mentioned service application platform (e.g., a webpage), and input the authorization period corresponding to each service. For example, assuming that the software products provided by the product server 11 include services such as A, B, and C, and the service applicant 19 only intends to purchase services such as A and B, then the service applicant 19 may, for example, choose to purchase service plans such as A and B on the service application platform, and input the corresponding authorization start time and authorization end time.

In one embodiment, the service applied by the service applicant 19 and the corresponding authorization period may be referred to as service information SI, but not limited thereto.

In one embodiment, the service applicant 19 may also input the predetermined hardware information HI of the electronic device that is expected to run the applied services in the future on the service application platform. In the embodiment of the disclosure, the considered predetermined hardware information HI includes, for example, the device hardware manufacturing serial number and/or the device motherboard serial number, but not limited thereto.

For example, assuming that the service applicant 19 expects to use an electronic device B to run the applied service in the future, when the service applicant 19 uses an electronic device A to log in the service application platform, the device hardware manufacturing serial number and/or the device motherboard serial number of the electronic device B may be input into the service application platform as the predetermined hardware information HI according to one's own knowledge about hardware, but not limited thereto. In this case, the electronic device used to apply for the service may not be the same as the electronic device used to run the applied service in the future, thereby improving the convenience of using the client.

In one embodiment, the product server 11 may also automatically scan the device hardware manufacturing serial number and/or the device motherboard serial number of the electronic device B as the predetermined hardware information HI when the user logs in the service application platform with the electronic device B. In this case, even if the service applicant 19 has insufficient hardware knowledge, the application on the service application platform may still be completed, however, the service is still required to be run on the electronic device B in the future (or other electronic devices with the same device hardware manufacturing serial number and/or device motherboard serial number as the electronic device B) in order to pass the verification and authorization.

Next, in step S220, the product server 11 generates a public key PK1 and a private key PK2 corresponding to the service application request RQ, and generates an image file IM corresponding to the service based on the service information SI of the service.

In one embodiment, the product server 11 may, for example, generate a public key PK1 and a private key PK2 corresponding to each other based on an asymmetric encryption technique. The private key PK2 may be used for encrypting the message that the issuer intends to publish, and the main purpose of this encryption process is to emphasize that the encrypted message is the content disclosed by the issuer and should not be forged. Afterwards, the verifier may use the obtained public key PK1 to decrypt the encrypted message, so as to acquire the message published by the issuer, but not limited thereto.

In an embodiment, the image file IM includes, for example, a product image file IM1 corresponding to the operating environment of the service. For example, assuming that the operating environment of the service applied by the service applicant 19 is a certain version of Linux™, the product server 11 may generate an image file corresponding to the operating environment of this version of Linux™ as the product image file IM1 after acquiring the service information SI. For another example, assuming that the operating environment of the service applied by the service applicant 19 is a certain version of Windows™, the product server 11 may generate an image file corresponding to the operating environment of this version of Windows™ as the product image file IM1 after acquiring the service information SI, but not limited thereto.

In an embodiment, the image file IM may further include a service image file IM2 corresponding to the applied service. For example, assuming that the service information SI indicates that the services applied by the service applicant 19 is service A and service B, then the product server 11 may generate one or more image files corresponding to service A and service B as the service image file IM2, but not limited thereto.

Afterwards, in step S230, the product server 11 generates a certificate CT based on the private key PK2, the predetermined hardware information HI, and the service information SI of the service, and stores the public key PK1, the certificate CT, and the image file IM in the storage device 12.

In one embodiment, the product server 11 may use the private key PK2 to encrypt the predetermined hardware information HI and the service information SI of the service to generate a certificate CT, and may store the certificate CT together with the public key PK1 and the image file IM (e.g., including the product image file IM1 and the service image file IM2) in the storage device 12.

Then, the product server 11 may deliver the storage device 12 storing the certificate CT, the public key PK1, and the image file IM to the service applicant 19 to be used by the service applicant 19.

In one embodiment, the service applicant 19 may connect the storage device 12 (e.g., various portable/fixed storage devices) to the electronic device 13 intended to run the applied service. The electronic device 13 may, for example, operate in a fully enclosed network environment, but not limited thereto.

In one embodiment, in order for the electronic device 13 to successfully run the service applied by the service applicant 19, the electronic device 13 is required to be the electronic device B previously used to apply for the service on the service application platform, or other electronic device with the same predetermined hardware information HI as the electronic device B.

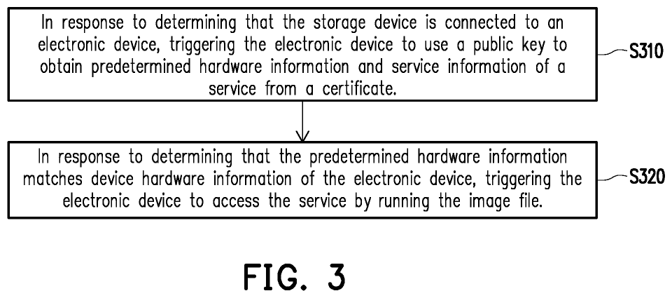

In one embodiment, after the storage device 12 is connected to the electronic device 13, the storage device 12 may correspondingly execute the method for verifying and authorizing by using a storage device shown in FIG. 3, which is further described below.

Referring to FIG. 3, FIG. 3 is a flowchart of a method for verifying and authorizing by using a storage device according to an embodiment of the disclosure. The method of this embodiment may be executed by the storage device 12 in FIG. 1, and the details of each step in FIG. 3 will be described below with reference to the elements shown in FIG. 1.

First, in step S310, in response to determining that the storage device 12 is connected to the electronic device 13, the storage device 12 triggers the electronic device 13 to use the public key PK1 to obtain the predetermined hardware information HI and the service information SI of the service from the certificate CT.

In one embodiment, the storage device 12 may trigger the electronic device 13 to decrypt the certificate CT with the public key PK1 to obtain the predetermined hardware information HI (e.g., the device hardware manufacturing serial number and/or the device motherboard serial number of the electronic device B) and the service information SI (e.g., the applied service and/or the corresponding authorization period) originally encrypted by the private key PK2.

In one embodiment, in response to determining that the storage device 12 is connected to the electronic device 13, the storage device 12 may also trigger the electronic device 13 to run the product image file IM1 in the image file IM to operate the operating environment of the service (such as Linux™ and/or Windows™).

In one embodiment, the storage device 12 may trigger the electronic device 13 to compare the device hardware information of the electronic device 13 with the predetermined hardware information HI (corresponding to the electronic device B). In one embodiment, the device hardware information of the electronic device 13 includes, for example, a device hardware manufacturing serial number and/or a device motherboard serial number of the electronic device 13. In this case, the electronic device 13 may determine whether its device hardware manufacturing serial number and/or device motherboard serial number respectively match the device hardware manufacturing serial number and/or device motherboard serial number in the predetermined hardware information HI. If yes (i.e., they match), this means that the electronic device 13 is the electronic device expected to be used by the service applicant 11 to run the applied service. Correspondingly, the storage device 12 may determine that the predetermined hardware information matches the device hardware information of the electronic device 13, and may proceed to step S320.

On the contrary, if the device hardware manufacturing serial number and/or the device motherboard serial number of the electronic device 13 do not respectively match the device hardware manufacturing serial number and/or the device motherboard serial number in the predetermined hardware information HI, this means that the electronic device 13 is not the electronic device expected to be used by the service applicant 11 to run the applied service. In other words, the electronic device 13 has not been authorized to use the service applied by the service applicant 11. Based on this, the storage device 12 may correspondingly trigger the electronic device 13 to provide a corresponding warning, and may trigger the electronic device 13 to stop subsequent verification and authorization actions, but not limited thereto.

In step S320, in response to determining that the predetermined hardware information matches the device hardware information of the electronic device, the storage device 12 triggers the electronic device 13 to access the service by running the image file IM.

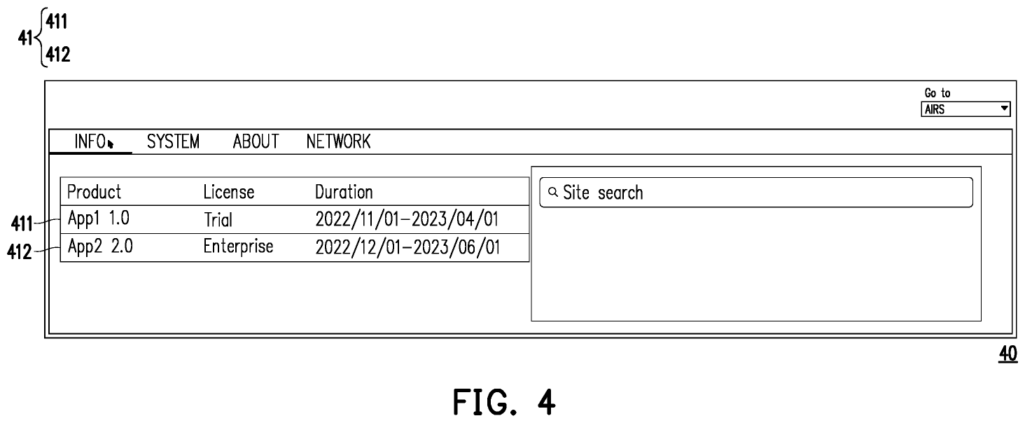

In one embodiment, in response to determining that the predetermined hardware information HI matches the device hardware information of the electronic device 13, the storage device 12 may trigger the electronic device 13 to provide a user interface 40 as shown in FIG. 4 in the above-mentioned operating environment to be operated by the user of the electronic device 13.

Referring to FIG. 4, FIG. 4 is a schematic diagram of a user interface according to an embodiment of the disclosure. In FIG. 4, the user interface 40 is, for example, a web interface, and may have a service menu 41. The service menu 41 may include service options 411 and 412 corresponding to different services, but not limited thereto.

In one embodiment, the service options 411 and 412 may, for example, display the authorization status and the authorization period of the corresponding service. For example, the service option 411 may correspond to a service named “App1 1.0”, and its authorization status and authorization period respectively are, for example, “Trial” and “2022/11/01 to 2023/04/01”. For another example, the service option 412 may correspond to a service named “App2 2.0”, and its authorization status and authorization period respectively are, for example, “Enterprise” and “2022/12/01 to 2023/06/01”. In one embodiment, the content of the service options 411 and 412 may be triggered by the storage device 12 to be generated by the electronic device 13 based on the service information SI, but not limited thereto.

In one embodiment, in response to determining that the service option corresponding to the applied service is selected, the storage device 12 may trigger the electronic device 13 to determine whether the service information SI of the service indicates that the electronic device 13 is authorized to use the corresponding service.

For example, assuming that the service option 411 is selected, the storage device 12 may trigger the electronic device 13 to determine whether the service information SI of the service indicates that the electronic device 13 is authorized to use the corresponding service (i.e., “App1 1.0”). In one embodiment, the electronic device 13 may be triggered to determine whether the current system time is within the authorization period of the selected service (i.e., “App1 1.0”). If yes (i.e., the current system time is within the authorization period), this means that the electronic device 13 still has the authorization to use the service “App1 1.0”, so the storage device 12 may trigger the electronic device 13 to determine that the service information SI indicates that the electronic device is authorized to use the service “App1 1.0”.

In one embodiment, in response to determining that the service information SI of the service indicates that the electronic device 13 is authorized to use the service, the storage device 12 triggers the electronic device 13 to run the service image file IM2 to use the service.

On the other hand, if the current system time of the electronic device 13 is not within the authorization period of the selected service (i.e., “App1 1.0”), this means that the electronic device 13 does not have the authorization to use the service “App1 1.0”. In this case, the storage device 12 may not trigger the electronic device 13 to run the service image file IM2, and may further trigger the electronic device 13 to provide a relevant warning message, so as to notify the user of the electronic device 13 of the unauthorized use of the selected service with the electronic device 13, but not limited thereto.

In this way, even if the electronic device 13 operates in a fully enclosed network environment, the electronic device 13 may still successfully determine whether the electronic device 13 has the authority to run various services through the trigger of the storage device 12. Therefore, the solutions proposed in the embodiments of the disclosure may be applied to customers with fully enclosed network environments such as the Health Insurance Administration, the Health Promotion Administration, and major hospitals, but not limited thereto.

To sum up, in the embodiments of the disclosure, the product server may use the private key to encrypt the predetermined hardware information and the service information of the applied service into a certificate according to the requirements of the service applicant, and may store the public key, the certificate, and image file corresponding to the service in the storage device. Afterwards, when the user connects the storage device to an electronic device, the storage device may correspondingly trigger the electronic device to decrypt the certificate with the public key to obtain the predetermined hardware information and the service information of the applied service, and may determine whether the electronic device is authorized to use various services. In this way, even if the electronic device is in a fully enclosed network environment, the concept of the embodiment of the disclosure may still determine whether the electronic device has the authority to run various services through the trigger of the storage device 12.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A storage device, storing a public key, a certificate, and at least one image file corresponding to a service, the storage device is configured to:
in response to determining that the storage device is connected to an electronic device, trigger the electronic device to obtain predetermined hardware information and service information of the service from the certificate by using the public key; and
in response to determining that the predetermined hardware information matches device hardware information of the electronic device, trigger the electronic device to access the service by running the at least one image file, wherein the service information of the service indicates that the electronic device is authorized to use the service.

2. The storage device according to claim 1, wherein the at least one image file comprises a product image file corresponding to an operating environment of the service, and the storage device is further configured to:
in response to determining that the storage device is connected to the electronic device, trigger the electronic device to run the product image file to operate the operating environment of the service.

3. The storage device according to claim 2, wherein the storage device is further configured to:
in response to determining that the predetermined hardware information matches the device hardware information of the electronic device, trigger the electronic device to provide a user interface in the operating environment, wherein the user interface has a service menu, and the service menu comprises a service option corresponding to the service; and
in response to determining that the service option is selected, trigger the electronic device to determine whether the service information of the service indicates that the electronic device is authorized to use the service.

4. The storage device according to claim 1, wherein the at least one image file further comprises a service image file corresponding to the service, and the storage device is further configured to:
in response to determining that the service information of the service indicates that the electronic device is authorized to use the service, trigger the electronic device to run the service image file to use the service.

5. The storage device according to claim 1, wherein the predetermined hardware information comprises a predetermined hardware manufacturing serial number, and the device hardware information comprises a device hardware manufacturing serial number, wherein in response to determining that the predetermined hardware manufacturing serial number matches the device hardware manufacturing serial number, it is determined that the predetermined hardware information matches the device hardware information of the electronic device.

6. The storage device according to claim 1, wherein the predetermined hardware information comprises a predetermined motherboard serial number, and the device hardware information comprises a device motherboard serial number, wherein in response to determining that the predetermined motherboard serial number matches the device motherboard serial number, it is determined that the predetermined hardware information matches the device hardware information of the electronic device.

7. The storage device according to claim 1, wherein the service information of the service comprises an authorization period of the service, and in response to determining that a system time of the electronic device is within the authorization period, it is determined that the service information of the service indicates that the electronic device is authorized to use the service.

8. The storage device according to claim 1, wherein the storage device is a portable storage device or a fixed storage device.

9. A method for verifying and authorizing by using a storage device, the storage device storing a public key, a certificate, and at least one image file corresponding to a service, the method comprising:
in response to determining that the storage device is connected to an electronic device, obtaining predetermined hardware information and service information of the service from the certificate by using the public key; and
in response to determining that the predetermined hardware information matches device hardware information of the electronic device, accessing the service by running the at least one image file, wherein the service information of the service indicates that the electronic device is authorized to use the service.

10. The method according to claim 9, wherein the at least one image file comprises a product image file corresponding to an operating environment of the service, the method further comprising:
in response to determining that the storage device is connected to the electronic device, running the product image file to operate the operating environment of the service.

11. The method according to claim 10, further comprising:
in response to determining that the predetermined hardware information matches the device hardware information of the electronic device, providing a user interface in the operating environment, wherein the user interface has a service menu, and the service menu comprises a service option corresponding to the service; and
in response to determining that the service option is selected, determining whether the service information of the service indicates that the electronic device is authorized to use the service.

12. The method according to claim 9, wherein the at least one image file further comprises a service image file corresponding to the service, and the method further comprises:
in response to determining that the service information of the service indicates that the electronic device is authorized to use the service, running the service image file to use the service.

13. The method according to claim 9, wherein the predetermined hardware information comprises a predetermined hardware manufacturing serial number, and the device hardware information comprises a device hardware manufacturing serial number, wherein the method further comprises:
in response to determining that the predetermined hardware manufacturing serial number matches the device hardware manufacturing serial number, determining that the predetermined hardware information matches the device hardware information of the electronic device.

14. The method according to claim 9, wherein the predetermined hardware information comprises a predetermined motherboard serial number, and the device hardware information comprises a device motherboard serial number, wherein the method further comprises:
in response to determining that the predetermined motherboard serial number matches the device motherboard serial number, determining that the predetermined hardware information matches the device hardware information of the electronic device.

15. The method according to claim 9, wherein the service information of the service comprises an authorization period of the service, and the method further comprises:
in response to determining that a system time of the electronic device is within the authorization period, determining that the service information of the service indicates that the electronic device is authorized to use the service.

16. A verification and authorization system, comprising:
a storage device; and
a product server, configured to
in response to a service application request, obtain predetermined hardware information and service information of a service that is applied;
generate a public key and a private key corresponding to the service application request, and generate at least one image file corresponding to the service based on the service information of the service; and
generate a certificate based on the private key, the predetermined hardware information, and service information of the service, and store the public key, the certificate, and the at least one image file in the storage device.

17. The system according to claim 16, wherein the storage device is configured to execute:
in response to determining that the storage device is connected to an electronic device, triggering the electronic device to obtain the predetermined hardware information and the service information of the service from the certificate by using the public key; and
in response to determining that the predetermined hardware information matches device hardware information of the electronic device, triggering the electronic device to access the service by running the at least one image file, wherein the service information of the service indicates that the electronic device is authorized to use the service.

18. The system according to claim 17, wherein the at least one image file comprises a service image file of the service and a product image file corresponding to an operating environment of the service, and the storage device is configured to:
in response to determining that the storage device is connected to the electronic device, trigger the electronic device to run the product image file to operate the operating environment of the service;
in response to determining that the predetermined hardware information matches the device hardware information of the electronic device, trigger the electronic device to provide a user interface in the operating environment, wherein the user interface has a service menu, and the service menu comprises a service option corresponding to the service;
in response to determining that the service option is selected, trigger the electronic device to determine whether the service information of the service indicates that the electronic device is authorized to use the service; and
in response to determining that the service information of the service indicates that the electronic device is authorized to use the service, trigger the electronic device to run the service image file to use the service.

19. The system according to claim 17, wherein the predetermined hardware information comprises a predetermined hardware manufacturing serial number or a predetermined motherboard serial number, and the device hardware information comprises a device hardware manufacturing serial number or a device motherboard serial number, wherein the storage device executes:
in response to determining that the predetermined hardware manufacturing serial number or the predetermined motherboard serial number respectively matches the device hardware manufacturing serial number or the device motherboard serial number, triggering the electronic device to determine that the predetermined hardware information matches the device hardware information of the electronic device.

20. The system according to claim 17, wherein the service information of the service comprises an authorization period of the service, and the storage device executes:
in response to determining that a system time of the electronic device is within the authorization period, triggering the electronic device to determine that the service information of the service indicates that the electronic device is authorized to use the service.
